(19) United States
(12) Patent Application Publication
(10) Pub. No.: US 2006/0083017 A1
(43) Pub. Date: Apr. 20, 2006

(54) Solid-state lighting apparatus for navigational aids

(75) Inventors: Sean Xiaolu Wang, Wilmington, DE (US); Rongsheng Tian, Newark, DE (US); Qingxiong Li, Newark, DE (US); Qun Li, Newark, DE (US)

Correspondence Address: BLANK ROME LLP, 600 NEW HAMPSHIRE AVENUE, N.W., WASHINGTON, DC, 20037, US

(73) Assignee: BWT Propety, Inc., Newark, DE (US)

(21) Appl. No.: 11/252,246

(22) Filed: Oct. 18, 2005

Related U.S. Application Data
(60) Provisional application No. 60/619,012, filed on Oct. 18, 2004.

(51) Int. Cl. F21V 21/00

(52) U.S. Cl. 362/547; 362/545

(57) ABSTRACT

A high intensity solid-state lighting apparatus is disclosed for the application of navigational aids. In various embodiments based on the approach of chip-on-board packaged semiconductor light emitting elements, unidirectional, bidirectional as well as omni-directional navigational lights are configured to meet high luminous intensity requirements. They also provide additional utilities for generating multiple colors and flash patterns with the same light unit for lighting reconfiguration as well as creating new means of signaling. Another purpose of the current invention is to provide a light source which will not cause vertigo effects.

### REFERENCE TO RELATED APPLICATION

The present application claims the benefit of U.S. Provisional Patent Application No. 60/619,012, filed Oct. 18, 2004, whose disclosure is hereby incorporated by reference in its entirety into the present disclosure.

### FIELD OF INVENTION

The present invention generally relates to a lighting apparatus and more specifically to a high brightness solid-state lighting apparatus for navigational aids.

### BACKGROUND OF THE INVENTION

Lighting is an integral part of the safety system for airports as well as helipads and waterways, providing guidance, signaling, and demarcation of aircraft runways and taxiways. The lighting system includes those elevated/in-pavement taxiway and runway lights, medium and high intensity approach lights, which can be further configured as edge, centerline, threshold/end, hold-line, stop bar, and runway guard lights. Light emitting diode (LED) sources have been identified to be the replacement for the conventional incandescent lighting apparatus as they offer many advantages including high energy efficiency, long lifetime, low maintenance cost, enhanced reliability and durability, and no lumen loss induced by filtering.

The prior art related to LED lighting systems includes U.S. Pat. Nos. 5,926,115, 6,086,220, 6,489,733, 6,902,291 and U.S. Patent Application Nos. 2002/0114161, 2003/0193807, 2004/0095777. In U.S. Pat. No. 6,489,733, Schmidt et al. disclose a multi-purpose lighting system for airport, roads or the like. The lighting system is composed of a group of incandescent or LED light sources and a central control unit to monitor and control the operation of the light sources. In U.S. Pat. No. 5,926,115, Schleder et al. disclose a microprocessor-controlled airfield series lighting circuit communications system and the corresponding method that allows bi-directional communication between the controlling microprocessor and the airfield lamps. In U.S. Pat. No. 6,086,220, Lash et al. disclose a marine safety light consisting of a plurality of LEDs arranged in a star configuration. In U.S. Pat. No. 6,902,291, Rizkin et al. disclose an in-pavement directional LED luminaire, which utilizes multiple high flux LEDs with thermostabilization and uses a single non-imaging element as a secondary optic. In U.S. Patent Application No. 2002/0114161, Barnett discloses a rotating warning lamp having an LED based planar light source. In U.S. Patent Application No. 2003/0193807, Rizkin et al. disclose an LED-based elevated omni-directional airfield light. In U.S. Patent Application No. 2004/0095777, Trenchard et al. disclose a high flux marine safety light having a plurality of high flux LEDs mounted on a heat sink and surrounded by a diffuser.

The LED lighting apparatuses disclosed in those references have a luminous intensity of <100 candelas. That luminous intensity does not meet the needs for runway edge lighting, approach lighting, threshold/end lighting, and obstruction/beacon lighting.

For some airport lighting/signaling applications, it is also desirable that the color of the lamp can be easily changed or switched within the same light fixture. As an example, a taxi way may be reconfigured to a temporary runway by switching the light color from blue to white. That is difficult to achieve in a conventional incandescent lamp, where the color is usually defined by the color of the glass cover.

The color of the light used in navigation and airport applications is governed by various standards and regulations. The utility of an installed light is defined not only by its intensity, but also by its chromatic characteristics (optical spectral distribution). Unfortunately, during the lifetime of an LED, not only will the light intensity decay gradually, but also, its chromatic characteristics will change, which can further shorten the useful lifetime of the LED. It is also true that the chromatic property of the LED is further affected by the environmental temperature. The LED will be red shifted with an elevated temperature and blue shifted with a reduced temperature. It is thus desirable that the chromatic characteristics may be varied during the useful lifetime of an LED.

Many LED based airport lights are currently modulated in their output at a rate of about 50-60Hz in order to reduce the thermal load. That helps to maintain the performance of the LED and prolong the lifetime, especially for a battery operated lighting unit. However, even though the naked human eyes can not sense the fast flickering (modulation), the modulation creates an artificial illusion to a pilot wearing night vision goggles and may cause dizziness and vertigo.

### SUMMARY OF THE INVENTION

It is therefore an objective of the present invention to provide an airport/navigational lighting apparatus which can solve all the above mentioned problems.

To achieve the above and other objectives, the current invention in at least some of its embodiments utilizes newly developed high intensity LEDs or LED arrays with a chip-on-board (COB) package, in which the LED chips are directly surface-mounted on a thermal conductive substrate for improved heat dissipation. In one aspect, the COB package allows much higher current to be applied on the LED chip to increase its output power. In another aspect, the packing density of the LED chips can be greatly increased by over one order of magnitude. As a result, the LED lighting apparatus disclosed in the current invention achieves a luminous intensity of several hundred or even several thousand candelas.

In various preferred embodiments, the following description will provide detailed optical and mechanical design for unidirectional, bidirectional as well as omni-directional navigational lights that are built on COB packaged LEDs or LED arrays to meet high luminous intensity requirements. Color control and chromatic management is realized by integrating multiple wavelength LED chips into one lighting apparatus and controlling the relative intensity of those LED chips. Due to its improved heat dissipation capability, the LED lighting apparatus disclosed in the current invention can work in continuous mode with no modulation, thus completely eliminating the risk of vertigo.

### BRIEF DESCRIPTION OF THE DRAWINGS

FIG. 1 illustrates a chip-on-board (COB) LED package;

FIG. 2 illustrates an omni-directional lighting apparatus constructed with COB LED arrays;

FIG. 3 illustrates a bidirectional lighting apparatus constructed with COB LED arrays;

FIG. 4 illustrates a unidirectional glide slope light constructed with two COB LED arrays with different colors;

FIG. 5 (a) illustrates the illumination pattern of a glide slope light formed by two COB LED arrays with different colors;

FIG. 5 (b) illustrates the illumination pattern of another glide slope light formed by three COB LED arrays with different colors;

FIG. 5 (c) illustrates the illumination pattern of a centerline light formed by COB LED arrays with different flash patterns; and

FIG. 6 illustrates a traditional LED package.

### DETAILED DESCRIPTION OF THE PREFERRED EMBODIMENTS

Preferred embodiments of the present invention will now be set forth in detail with reference to the drawings, in which like reference numerals refer to like elements throughout.

A traditional LED light utilizes a small LED chip mounted on a reflector cup as shown in FIG. 6. That kind of package is generally referred to as T-pack. In the traditional LED light 600, an LED chip 602 and a gold wire 604 are enclosed in an epoxy lens 606. The LED is attached by a cathode 608 and an anode 610 to a printed circuit board (substrate) 612.

The traditional LED light 600 has very high thermal resistance (>200K/W) due to a poor heat sink. Thus, its input power is limited to <0.1-Watt to keep the operating temperature of the PN junction at <120° C. safety level. Due to the limitation of achievable individual LED brightness, a large number of LED lights are required to meet the luminous intensity requirements, which results in a large footprint due to the size of each T-pack device (several millimeters) and only 1-5% of the total LED array surface is light emitting.

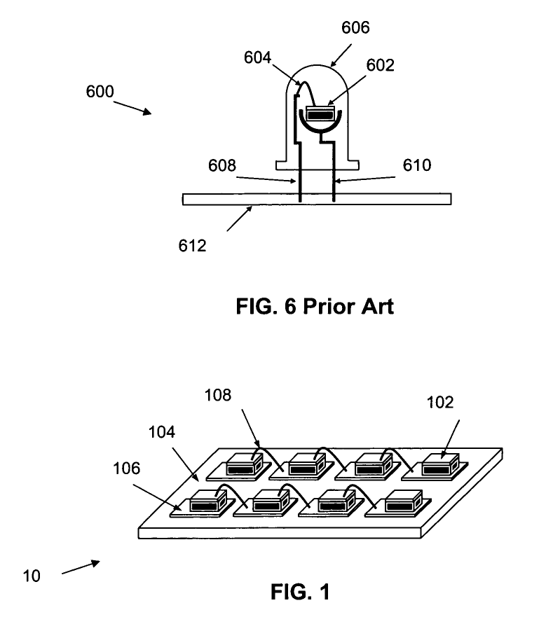

An illustration of the COB packaged high intensity LED array is shown in FIG. 1 as 10. In that approach, multiple LED chips 102 are densely mounted on a common thermally conductive substrate 104 made of fiberglass-filled epoxy, ceramic, or metal with a small spacing such as 100 μm. Electrical connections are provided via electrodes 106 and gold wires 108.

That high packing density results in a light emitting surface of up to 85% of the total LED array surface. Thus, the luminous intensity of the LED array is greatly increased (by over one order of magnitude). More importantly, the COB approach provides superior thermal control over conventional T-pack devices as the LED chips are directly attached on the substrate with their whole surfaces as the heat dissipation channel. In comparison, the T-pack LED can only dissipate its heat through the electrodes. The improved heat-sinking keeps the temperature of the LED PN junction as low as possible, which makes the LED capable of operating at higher currents or output levels. It also leads to long lifetime as well as wavelength (color) and intensity (brightness) stability. Other advantages of the COB approach include compact size, high uniformity, and capability for color management by integrating LED chips with different colors. The goal of the present invention is to utilize the COB packaged LEDs or LED arrays to build high intensity lighting apparatus for navigational aids.

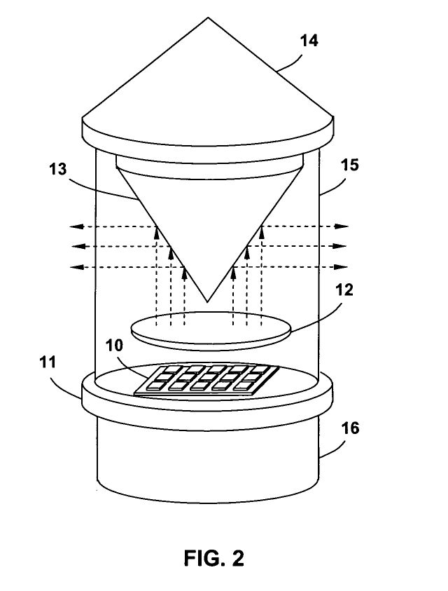

In one preferred embodiment of the current invention, as shown in FIG. 2, an omni-directional lighting apparatus is constructed on COB LED arrays, which can be used as an elevated runway edge light, or obstruction/beacon light. The lighting apparatus comprises one or more high intensity COB LED arrays 10 mounted on a thermally conductive substrate 11. The light beam emitted from the LED arrays is first collected and collimated by a group of lenses 12 and then transformed into a horizontal beam with a 360° C. illumination angle by a cone shaped reflector 13. The divergence of the LED beam in the vertical plane is collimated to an application required angle, such as <10° C. for a runway edge light. The LED arrays 10, the lens sets 12 and the reflector 13 are enclosed in a waterproof housing composed of a cover 14, a cylindrically shaped transparent window 14, and an electronic compartment 16 holding all the electronic driver and control circuits. For reason of simplicity, the electronic wire connections are not shown in the figure. A beam homogenizer, such as a holographic diffuser described by Lieberman et al. in U.S. Pat. No. 6,446,467, can be inserted between the lenses 12 and the reflector 13 to further improve the uniformity of the LED beam and control the vertical illumination angle. By alternatively placing LED chips with different colors (such as red, green and blue) on the substrate to form a color matrix and controlling the relative intensity of those LED chips, the color of the lighting apparatus can be adjusted for lighting reconfiguration or to maintain/adjust the chromatic property of the lighting apparatus during its lifetime. In a slight variation of the current embodiment, the COB LED arrays further comprise invisible LED chips such as in the infrared wavelength region that are placed alone or alternatively with the visible LED chips to provide navigational aids during dark conditions for pilots wearing night vision goggles.

In another embodiment of the current invention, as shown in FIG. 3, a bidirectional lighting apparatus is constructed as an elevated threshold light. The lighting apparatus comprises two COB LED arrays 20 and 21 with different emission wavelengths (colors) such as green and red, which are mounted on a heat sink 22 in opposite directions. The light beams from the two LED arrays 20 and 21 are collected and collimated by the lens sets 23 and 24, respectively. The spread angle of the LED beams is set according to the application requirements. In the current embodiment, the LED lighting apparatus exhibits a luminous intensity of >2000 cd in a divergence angle of <10° C. The LED arrays and the lens sets are enclosed in a waterproof housing composed of a cover 25, a cylindrical shaped transparent window 26, a heat sink 27, and an electronic compartment 28. As a slight variation of the above embodiment, two kinds of LED chips with different colors such as green and red may be integrated in the same COB array. By simply turning on/off a particular color, the beginning or end of runway can be reconfigured so that aircraft can be directed in different directions. A unidirectional lighting apparatus with COB LED arrays emitting at one direction can be constructed similarly, which can be used as an airport strobe light.

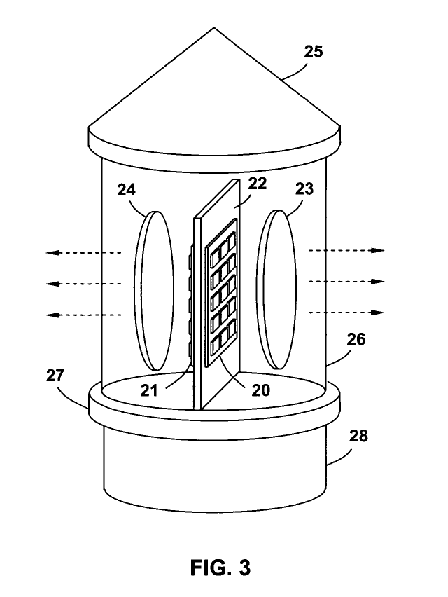

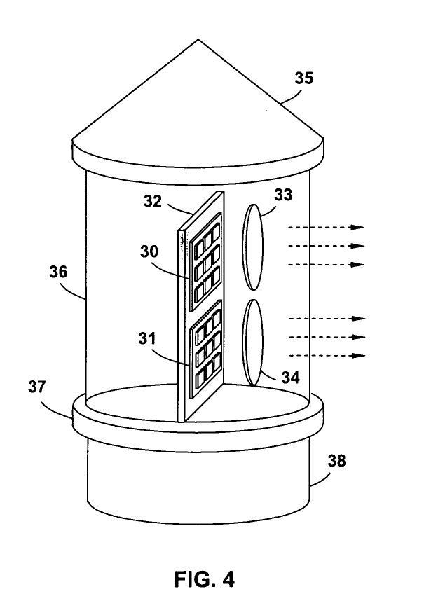

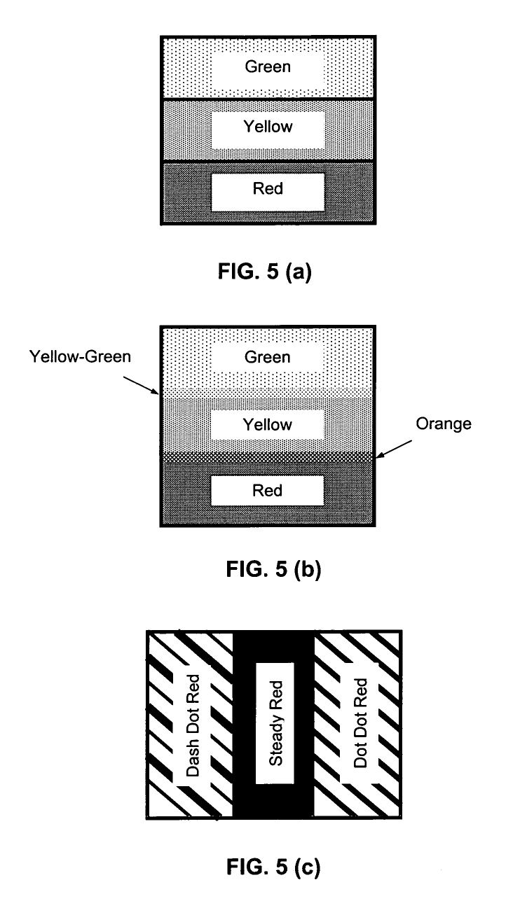

In yet another embodiment of the current invention as shown in FIG. 4, the COB LED array is employed to build a unidirectional glide slope light to guide the landing path of an aircraft. In the present embodiment, the lighting apparatus is composed of two COB LED arrays 30, 31 mounted on a heat sink 32. Each LED array is assigned a unique emission color, such as green and red in the current embodiment. The two LED arrays emit in slightly diverged angles. The divergence angles of the two LED beams are controlled by the two lens sets 33, 34 in such a way that the two beams mix in the central region to form a yellow color as shown in FIG. 5 (a). That yellow color region represents a range of safe glide slope for the approaching aircraft to land. If the pilot sees the red or green color, it means that the glide path is either too deep or too shallow. Due to the high brightness of the COB LED array, the light can be seen by the pilot from a long distance away. The whole lighting unit is enclosed in a waterproof housing comprising a cover 35, a cylindrical shaped transparent window 36, a heat sink 37, and an electronic compartment 38. In a slight variation of the current embodiment, three LED arrays with different emission colors, such as green, yellow and red, are used instead. In that scheme, the LED beams are collimated to very small divergence angles so that a quasi three-color illumination pattern, as shown in FIG. 5 (b) is formed by the three LED arrays. In another variation of the current embodiment as shown in FIG. 5 (c), three COB LED arrays with different flash patterns are employed to build a centerline light to guide the aircraft to the centerline of the runway. In that scheme, the central LED array emits in a steady color such as red, while the left and right LED arrays emit in flashing red color with different flash patterns. The pilot determines the position of the aircraft from the flash pattern he or she observed. In both of the two above-mentioned embodiments for glide slope light and centerline light, the flash pattern and emission color of the LED arrays can be used in a combined manner as position indicators. The color of the LED arrays can be extended from visible to infrared regime to be seen through night vision goggles.

Since the COB LED array has much smaller thermal resistance than the T-pack LED clusters, the lighting apparatus disclosed in the current invention can operate with no modulation, which completely eliminates the risk of vertigo. In cases where ultra high luminous intensity is required, the LED array can be modulated at a high frequency such as several hundred to several thousand Hertz to reduce the thermal load while minimizing the vertigo risk.

While some preferred embodiments of the present invention have been set forth in detail, those skilled in the art who have reviewed the present disclosure will readily appreciate that other embodiments can be realized within the scope of the invention. For example, the COB light emitting chip array may also comprise vertical cavity surface emitting laser (VCSEL) diode chips. The color and luminous intensity of the LEDs cited in the specific embodiments are illustrative rather than limiting. Therefore, the present invention should be construed as limited only by the appended claims.

We claim:

1. A solid-state lighting apparatus for use in an airport, a helipad, or a waterway as a navigational aid, the lighting apparatus comprising:
a. at least one high luminous intensity LED or LED array for producing one or more light beams for illumination and signaling, wherein the at least one LED or LED array is provided as a chip-on-board (COB) package which comprises a thermally conductive substrate and a plurality of LED chips which are directly surface mounted on the thermally conductive substrate;
b. a passive optical component for shaping said light beams; and
c. an electronic circuit for controlling the light beams of said LEDs or LED arrays to function as said navigational aid.

2. The lighting apparatus of claim 1, wherein the at least one LED or LED array emits in a visible wavelength regime.

3. The lighting apparatus of claim 1, wherein the at least one LED or LED array emits in an infrared wavelength regime.

4. The lighting apparatus of claim 1, wherein the LED chips have a single emission wavelength.

5. The lighting apparatus of claim 1, wherein the LED chips have multiple emission wavelengths.

6. The lighting apparatus of claim 5, wherein the electronic circuit controls a chromatic property of the LED or LED array by controlling a relative intensity of the LED chips with different emission wavelengths.

7. The lighting apparatus of claim 5, wherein the emission wavelengths of the LED chips arrays vary in a spatial domain, and wherein the electronic circuit uses said emission wavelength variation for signaling.

8. The lighting apparatus of claim 1, wherein the LED or LED array operates in a continuous mode.

9. The lighting apparatus of claim 1, wherein the LED or LED array operates in flashing modes.

10. The lighting apparatus of claim 9, wherein a plurality of the LEDs or LED arrays have multiple flash patterns.

11. The lighting apparatus of claim 10, wherein the flash patterns of the LEDs or LED arrays vary in spatial domain, and wherein said flash pattern variation is used for signaling.

12. The lighting apparatus of claim 1, wherein the passive optical component comprises one or more lenses to collect and collimate the light beams from the at least one LED or LED array.

13. The lighting apparatus of claim 1, wherein the passive optical component comprises one or more light beam homogenizers.

14. The lighting apparatus of claim 1, wherein the passive optical component comprises one or more cone shaped reflectors to transform the shape of the light beams from the at least one LED or LED array.

15. The lighting apparatus of claim 1, wherein the electronic circuit modulates an intensity of the at least one LED or LED array at a high frequency to reduce a thermal load, and wherein said frequency is high enough to avoid a vertigo effect in a human observer.

16. The lighting apparatus of claim 1, further comprising VCSELs or VCSEL arrays in said COB package.

17. A method for providing lighting in an airport, a helipad, or a waterway as a navigational aid, the method comprising:
a. providing at least one high luminous intensity LED or LED array in said airport, helipad, or waterway to produce one or more light beams for illumination and signaling, wherein the at least one LED or LED array is provided as a chip-on-board (COB) package which comprises a thermally conductive substrate and a plurality of LED chips which are directly surface mounted on the thermally conductive substrate;
b. providing a passive optical component to shape the light beams of said at least one LED or LED array; and
c. using an electronic circuit to control said at least one LED or LED array to provide said navigational aid.

18. The method of claim 17, wherein the at least one LED or LED array emits in a visible wavelength regime.

19. The method of claim 17, wherein the at least one LED or LED array emits in an infrared wavelength regime.

20. The method of claim 17, wherein the LED chips have single emission wavelength.

21. The method of claim 17, wherein LED chips have multiple emission wavelengths.

22. The method of claim 21, wherein step (c) comprises controlling a chromatic property of the at least one LED or LED array by controlling a relative intensity of the LED chips with different emission wavelengths.

23. The method of claim 21, wherein the emission wavelengths of the LED chips vary in a spatial domain, and wherein step (c) comprises using said emission wavelength variation for signaling.

24. The method of claim 17, wherein the at least one LED or LED array operates in a continuous mode.

25. The method of claim 17, wherein the at least one LED or LED array operates in flashing modes.

26. The method of claim 25, wherein a plurality of the LEDs or LED arrays have multiple flash patterns.

27. The method of claim 26, wherein the flash patterns of the LEDs or LED arrays vary in a spatial domain, and wherein step (c) comprises using said flash pattern variation for signaling.

28. The method of claim 17, wherein the passive optical component comprises one or more lenses to collect and collimate the light beams from the at least one LED or LED array.

29. The method of claim 17, wherein the passive optical component comprises one or more light beam homogenizers.

30. The method of claim 17, wherein the passive optical component comprises one or more cone shaped reflectors to transform the shape of the light beams from the at least one LED or LED array.

31. The method of claim 17, wherein step (c) comprises modulating an intensity of the at least one LED or LED array at a high frequency to reduce a thermal load, and wherein said frequency is high enough to avoid a vertigo effect in a human observer.

32. The method of claim 17, wherein step (a) comprises providing VCSELs or VCSEL arrays in said COB package.
